(19) United States
(12) Patent Application Publication
(10) Pub. No.: US 2003/0086866 A1
(43) Pub. Date: May 8, 2003

(54) Compact combined shift and selective methanation reactor for co control

(76) Inventors: James R. Wangerow, Lemont, IL (US); Chakravarthy Sishtla, Woodridge, IL (US); Andy H. Hill, Glen Ellyn, IL (US); Michael Onischak, St. Charles, IL (US)

Correspondence Address: Mark E. Fejer, Pauley Petersen Kinne & Fejer, Suite 365, 2800 West Higgins Road, Hoffman Estates, IL, 60195, US

(21) Appl. No.: 10/015,042

(22) Filed: Oct. 26, 2001

(51) Int. Cl. C01B 3/12; B01J 8/02

(52) U.S. Cl. 423/648.1; 422/190; 422/211

(57) ABSTRACT

A reactor for CO control having a reactor vessel having a water-gas shift catalyst zone, a mixed catalyst zone downstream of the water-gas shift catalyst zone, and a methanation catalyst zone disposed downstream of the mixed catalyst zone, at least one water-gas shift catalyst disposed in the water-gas shift catalyst zone, at least one methanation catalyst disposed in the methanation catalyst zone, and a mixture of the water-gas shift catalyst and the methanation disposed in the mixed catalyst zone.

### BACKGROUND OF THE INVENTION

1. Field of the Invention

This invention relates to a method and apparatus for controlling the CO content of a reformate fuel gas suitable for use in electrochemical devices for producing electricity, such as polymer electrolyte membrane (PEM) fuel cells. More particularly, this invention relates to a synergistic configuration of a compact and efficient fuel processor for producing a low-carbon monoxide content product gas from a variety of hydrocarbon fuels, including, but not limited to, methane, propane and methanol.

2. Description of Prior Art

Fuel cells are known apparatuses in which the chemical energy of a fuel is converted directly into electrical energy. Each fuel cell generally includes a pair of electrodes arranged across an electrolyte, wherein the surface of one electrode (the anode) is exposed to a reactive hydrogen-rich fuel gas while the surface of the other electrode (the cathode) is exposed to an oxidizing gas containing oxygen. The electrical energy is generated between the electrodes through the electrochemical reactions proceeding from such exposures.

In general, the hydrogen-rich fuel gas supplied to such fuel cells is generated by a fuel processor comprising a steam-reforming process in which a hydrocarbon or carbonaceous fuel is converted to a reformate fuel gas comprising H₂ and CO₂. However, during the reforming process, a significant amount of CO is also generated which remains in the reformate fuel gas. The CO, when left in the reformate fuel gas, is absorbed by the platinum or platinum-containing catalyst typically employed in the anode electrode of the fuel cell, i.e. poisoning the catalyst, resulting in a reduction in the overall performance of the fuel cell. Thus, to avoid poisoning of the fuel cell, it is desirable to reduce the CO content of the reformate to as low a level as possible. Indeed, carbon monoxide concentrations of less than about 20 ppm in the reformate fuel gas are required to attain adequate performance and endurance, even with new developments in mixed platinum catalysts.

As a result, conventional fuel processors for fuel cell systems also include a water-gas shift unit in which the CO in the reformate fuel gas is converted along with water to H₂ and CO₂. To reduce the CO concentration to less than about 20 ppm, conventional fuel processors often further include a selective methanation unit in which the majority of the remaining CO is converted to methane.

A variety of systems and methods aimed at preventing CO-poisoning of the anode catalyst of fuel cells are known. U.S. Pat. No. 5,071,719 teaches a fuel cell power plant utilizing hydrogen and carbon-oxide rich feed gas, a methanation unit for converting the feed gas into methanated gas, and a reforming catalyst bed for reforming the methanated gas to feed gas. Heat for methanation is provided by the waste heat from the fuel cell.

U.S. Pat. Nos. 6,066,410 and 6,007,934 teach a platinum/ruthenium catalyst for PEM fuel cells which is resistant to CO which includes finely dispersed alloy particles on a powdery, electrically conductive carrier material, which finely dispersed alloy particles have a mean crystallite size of about 0.5 to less than 2 nm.

U.S. Pat. No. 5,939,220 teaches a poison tolerant catalyst for PEM fuel cells comprising platinum, one or more metals selected from the group consisting of transitions metals, Group IIIA metals and Group IVA metals and Mo, W and oxides thereof, and reforming of hydrocarbon fuel and selective oxidation to convert CO to CO₂.

U.S. Pat. No. 5,922,488 teaches a CO-tolerant fuel cell electrode having a carbon-supported, platinum dispersed, non-stoichiometric, hydrogen-tungsten-bronze electrode catalyst, which catalyst oxidizes CO to CO₂.

U.S. Pat. No. 4,910,009 teaches a method for preventing CO poisoning in a PEM fuel cell by injecting oxygen into the fuel stream of the fuel cell, thereby oxidatively removing carbon monoxide.

U.S. Pat. No. 5,843,195 teaches a fuel reformer comprising a reformer unit for reforming methanol and water into a hydrogen-rich reformed gas and a partial oxidizing unit comprising a platinum-ruthenium alloy catalyst for oxidizing carbon monoxide in the reformed gas produced by the reformer unit to carbon dioxide.

And, finally, U.S. Pat. No. 5,712,052 teaches a fuel cell generator which includes a reformer comprising a reformer unit for decomposing methanol to carbon monoxide and hydrogen and for generating carbon dioxide and hydrogen from water and carbon monoxide generated by the decomposition reaction, a shift reaction unit for making the residual, non-reacted carbon monoxide in the reformer unit further react with water, and a partial oxidizing unit for oxidizing the residual, non-reacted carbon monoxide in the shift reaction unit. A CO sensor is disposed in the fuel supply to the fuel cell, which sensor triggers the addition of oxygen to the partial oxidizing unit when the amount of CO in the fuel gas is at an undesirable level.

Thus, it will be apparent from the prior art that a three-step catalytic process involving reforming, water-gas shift, and methanation is particularly suited for the purpose of reducing CO in fuel gases for fuel cells to acceptable levels. Conventionally, this three-step catalytic process is carried out in three sequentially disposed reactor vessels, which although relying upon the output from an upstream stage nevertheless are generally operated independently of one another.

### SUMMARY OF THE INVENTION

Accordingly, it is one object of this invention to provide a method and apparatus for producing a fuel gas for use in fuel cells, in which fuel gas the concentration of CO is reduced to acceptable levels.

It is another object of this invention to provide a method and apparatus for producing a fuel gas for use in fuel cells which utilize the three-step catalytic process of reforming, water-gas shift and methanation in a manner which reduces the number of reactor vessels required to carry out the process compared to conventional processes.

These and other objects of this invention are addressed by a reactor for CO-control comprising a reactor vessel having a water-gas shift catalyst zone, a mixed catalyst zone downstream of the water-gas shift catalyst zone, and a methanation catalyst zone downstream of the mixed catalyst zone. Disposed within the water-gas shift catalyst zone is at least one water-gas shift catalyst and disposed within the methanation zone is at least one methanation catalyst. A mixture of the water-gas shift catalyst and the methanation catalyst is disposed in the mixed catalyst zone which is disposed between the water-gas shift zone and the methanation zone. The result is a synergistic configuration of a compact and efficient fuel processor which produces a low-carbon monoxide content product gas from a variety of hydrocarbon fuels, including, but not limited to methane, propane and methanol. By carrying out the catalytic water-gas shift reaction and the catalytic selective carbon monoxide methanation reaction in the same vessel, the heat released from the water-gas shift catalyst zone can be advantageously utilized to control the conditions in the methanation catalyst zone. And, as a result of this more efficient heat management, the performance of the fuel processor is improved as is the system and overall electrical efficiency of PEMFC power systems. This configuration simplifies the reactor catalyst thermal control compared to conventional systems employing two separate reactors and, additionally, reduces the materials of construction and eliminates duplication in fabrication, piping, and control instrumentation, thereby reducing manufacturing costs.

### BRIEF DESCRIPTION OF THE DRAWINGS

These and other objects and features of this invention will be better understood from the following detailed description taken in conjunction with the drawings wherein:

FIG. 1 is a schematic diagram of a simplified reactor vessel for carrying out catalytic water-gas shift and catalytic selective methanation reactions in accordance with one embodiment of this invention; and

FIG. 2 is a diagram showing a typical operating temperature band as a function of reformate gas disposition within the reactor vessel.

### DESCRIPTION OF PREFERRED EMBODIMENTS

PEM fuel cells operate at 60 to 80° C. and are easily poisoned by high levels of carbon monoxide. Consequently, fuel processors that produce hydrogen-rich fuel gas for PEM fuel cells need to reduce carbon monoxide to low ppm levels. Specifically, carbon monoxide levels of less than about 20 ppm in the fuel cell fuel gases are necessary to attain adequate performance and endurance, even with new developments in mixed platinum-additive catalysts. Currently, to reduce the carbon monoxide level produced by reformers to below 20 ppm, two catalysts in two separate reactor vessels are employed, that is, one for water-gas shift and one for selective methanation of carbon monoxide. In accordance with the method and apparatus of this invention, the two catalysts are loaded into one vessel in a certain sequence of contiguous zones.

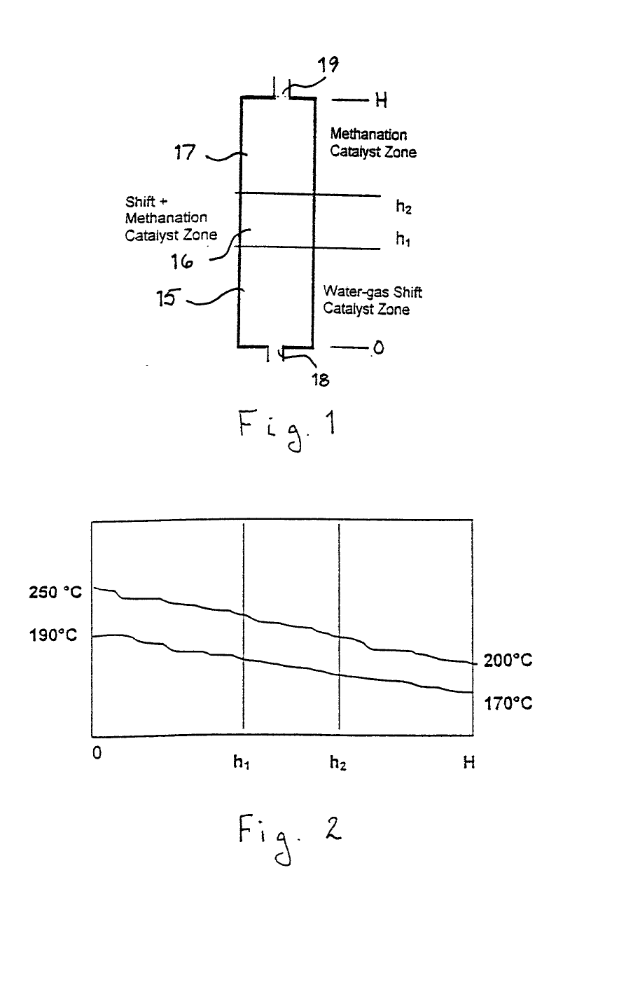

As shown in FIG. 1, the reactor vessel of this invention comprises a water-gas shift catalyst zone 15, a methanation catalyst zone 17 disposed downstream of the water-gas shift catalyst zone and a mixed catalyst zone 16 disposed between the water-gas shift catalyst zone 15 and the methanation catalyst zone 17. The reactor vessel forms a reformate fuel gas opening 18, whereby reformate fuel gas from a reformer is introduced into water-gas shift catalyst zone 15, and a reduced CO gas outlet 19, whereby reduced CO gas from the methanation catalyst zone 17 is removed.

Disposed within the water-gas shift catalyst zone is at least one water-gas shift catalyst. Any water-gas shift catalyst known to those skilled in the art may be employed in the reactor vessel of this invention. Such catalyst materials include Ni alloys, Cu alloys, Zn alloys and the like. In accordance with a particularly preferred embodiment of this invention, the water-gas shift catalyst is a Cu—Zn alloy available, for example, under the designation C12, C18 and C25 from United Catalyst, Inc., Louisville, Ky. Typically, the catalyst is disposed on a substrate material such as alumina or clay and comprises in the range of about 5% to about 30% by weight of the composite catalyst material. Disposed within the methanation catalyst zone is at least one methanation catalyst. Any methanation catalyst known to those skilled in the art may be employed. Suitable catalysts are catalysts comprising one or more metals including, but not limited to, nickel, iron, ruthenium, rhodium, palladium, platinum, and tungsten. However, the preferred methanation catalyst is ruthenium or a ruthenium alloy. The ruthenium catalyst is typically disposed on a substrate material such as alumina and comprises in the range of about 0.25% to about 2% by weight of the composite catalyst material.

The crux of this invention is the mixed catalyst zone 16 in which is disposed a mixture of water-gas shift catalyst and methanation catalyst. As known to those skilled in the art, the water-gas shift reaction

CO+H₂O→H₂+CO₂

is exothermic whereas the preferred methanation reaction

CO+H₂→CH₄+H₂O

is endothermic. We have found that by mixing the water-gas shift catalyst with the methanation catalyst, a synergistic effect is created whereby the heat released by the exothermic water-gas shift reaction can be employed as a means for controlling conditions in the selective methanation catalyst zone, for example reducing or even eliminating the requirement for auxiliary heat input to the methanation catalyst zone.

In conventional systems, the operating temperature of a water-gas shift reactor is typically in the range of about 170° C. to about 320° C. and the operating temperature of a selective methanation reactor is in the range of about 135° C. to about 200° C. By blending or mixing the water-gas shift catalyst and the selective methanation catalyst in the mixed catalyst zone of the reactor vessel of this invention, the operating temperature range for the water-gas shift catalyst is within about 20° C. of the proper selective methanation catalyst range. In addition to providing more efficient heat management, the reactor vessel of this invention enhances reformer performance and improves system and overall electrical efficiency of PEM fuel cell systems. Furthermore, this reactor vessel simplifies reactor catalyst thermal control compared to conventional systems employing two reactors, enables reductions in the materials of construction and eliminates duplication in fabrication, piping, and control instrumentation, thereby reducing manufacturing costs.

It will be apparent to those skilled in the art that the effectiveness of the mixed catalyst zone as a means for controlling conditions in the selective methanation catalyst zone is subject to substantial variation. That is, there are several operating parameters associated with the mixed catalyst zone which may be varied as a means for altering conditions within the mixed catalyst zone and, thus, the selective methanation catalyst zone. As previously indicated, any water-gas shift catalyst and selective methanation catalyst known to those skilled in the art may be employed in the reactor vessel of this invention. Indeed, multiple water-gas shift catalysts may be utilized simultaneously in the water-gas shift zone; multiple selective methanation catalysts may be utilized simultaneously in the methanation catalyst zone; and multiple water-gas shift catalysts and selective methanation catalysts may be utilized in the mixed catalyst zone. Furthermore, there is no requirement that the water-gas shift and selective methanation catalysts utilized in the mixed catalyst zone be the same as those used in the water-gas shift catalyst zone and the selective methanation catalyst zone, respectively.

However, it will be apparent to those skilled in the art that certain catalysts are more effective than other catalysts and that certain combinations of water-gas shift catalysts and selective methanation catalysts in the mixed catalyst zone may be more effective, assuming that the remaining operating parameters remain unchanged. Compensation for these differences in effectiveness may be accomplished by altering other operating parameters such as space velocity and the relative disposition of water-gas shift catalyst and selective methanation catalyst in the mixed catalyst zone. The preferred space velocity suitable for use in the reactor vessel of this invention is in the range of about 1500-2000 hr⁻¹. However, space velocity is dependent upon the form of catalyst substrate employed and, thus, may be higher or lower. In accordance with one particularly preferred embodiment of this invention, the water-gas shift catalyst and the selective methanation catalyst are disposed in the mixed catalyst zone so as to form a gradient whereby the concentration of selective methanation catalyst increases and the concentration of water-gas shift catalyst decreases in the direction of the methanation catalyst zone.

In accordance with the method of this invention for reducing the concentration of CO in a reformate fuel gas comprising CO, H₂, H₂O and CO₂, the reformate fuel gas is contacted with at least one water-gas shift catalyst disposed in a water-gas shift catalyst zone of a reactor vessel at a temperature suitable for reducing the amount of CO in the reformate fuel gas. The desired operating conditions of temperature, water content and space velocity for the water-gas shift catalyst zone are maintained by conventional methods of heat supply and water adjustment. The temperature within this zone is preferably in the range of about 190° C. to about 250° C. CO concentration in the reformate fuel gas at the entrance to the mixed catalyst zone is typically about 1% of the total reformate fuel gas, about 10,000 ppm. The reformate gas from the water-gas shift catalyst zone is contacted by a catalyst mixture comprising a water-gas shift catalyst and a selective methanation catalyst disposed in a mixed catalyst zone of the reactor vessel at a temperature suitable for further reducing the concentration of CO in the reformate fuel gas. The heat of reaction from the water-gas shift catalyst zone is carried downstream to the mixed catalyst zone for maintaining the mixed catalyst zone at the desired temperature. In accordance with a preferred embodiment of this invention, the temperature in the mixed catalyst zone is in the range of about 180° C. to about 230° C. The reformate fuel gas exiting from the mixed catalyst zone, having a CO concentration of about 1500 ppm or less, is then contacted with at least one selective methanation catalyst in a methanation catalyst zone of the reactor vessel. Temperature within the methanation catalyst zone is preferably in the range of about 170° C. to about 200° C. The concentration of CO in the reformate fuel gas exiting from the methanation catalyst zone is typically less than about 20 ppm. FIG. 2 shows a typical operating temperature band for a reactor vessel operating in accordance with the method of this invention, decreasing from an initial temperature at the reformate fuel gas inlet to the water-gas shift catalyst zone in the range of about 190° C. to about 250° C. to a final temperature proximate the reformate fuel gas outlet in the range of about 170° C. to about 200° C.

While in the foregoing specification this invention has been described in relation to certain preferred embodiments thereof, and many of the details have been set forth for purposes of illustration, it will be apparent to those skilled in the art that the invention is susceptible to additional embodiments and that certain of the details described herein can be varied considerably without departing from the basic principles of the invention.

We claim:

1. A reactor for CO control comprising:
a reactor vessel having a water-gas shift catalyst zone, a mixed catalyst zone downstream of the water-gas shift catalyst zone, and a methanation catalyst zone disposed downstream of the mixed catalyst zone;
at least one water-gas shift catalyst disposed in said water-gas shift catalyst zone;
at least one methanation catalyst disposed in said methanation catalyst zone; and
a mixture of said at least one water-gas shift catalyst and said at least one methanation catalyst disposed in said mixed catalyst zone.

2. A reactor in accordance with claim 1, wherein said mixture comprises a catalytic gradient whereby a concentration of said at least one methanation catalyst increases in a direction of said methanation catalyst zone.

3. A reactor in accordance with claim 1, wherein said at least one water-gas shift catalyst comprises Cu and Zn.

4. A reactor in accordance with claim 1, wherein said at least one methanation catalyst is selected from the group consisting of nickel, iron, ruthenium, platinum, rhodium and alloys and combinations thereof.

5. An apparatus for conversion of a hydrocarbon fuel to a fuel gas suitable for use in a fuel cell comprising:
a reformer vessel suitable for reforming said hydrocarbon fuel to a reformed gas mixture comprising CO, CO₂, H₂O and H₂;
a reactor vessel having a water-gas shift catalyst zone, a mixed catalyst zone downstream of said water-gas shift catalyst zone, and a methanation catalyst zone downstream of said mixed catalyst zone in fluid communication with said reformer vessel; and
at least one water-gas shift catalyst disposed in said water-gas shift catalyst zone, at least one methanation catalyst disposed in said methanation catalyst zone, and a mixture of said at least one water-gas shift catalyst and said at least one methanation catalyst disposed in said mixed catalyst zone.

6. An apparatus in accordance with claim 5, wherein said mixture comprises a catalytic gradient whereby a concentration of said at least one methanation catalyst increases in a direction of said methanation catalyst zone.

7. An apparatus in accordance with claim 5, wherein said at least one water-gas shift catalyst comprises Cu and Zn.

8. An apparatus in accordance with claim 5, wherein said at least one methanation catalyst is selected from the group consisting of nickel, iron, ruthenium, platinum, rhodium and alloys and combinations thereof.

9. An apparatus in accordance with claim 7, wherein said at least one methanation catalyst is selected from the group consisting of nickel, iron, ruthenium, platinum, rhodium and alloys and combinations thereof.

10. A method for reducing an amount of CO in a reformate fuel gas comprising CO, H₂, H₂O and CO₂ comprising the steps of:
contacting said reformate fuel gas with at least one water-gas shift catalyst disposed in a reactor vessel at a temperature suitable for reducing said amount of CO in said reformate fuel gas, forming a first stage reformate fuel gas having a reduced CO content;
contacting said first stage reformate fuel gas with a catalyst mixture comprising said at least one water-gas shift catalyst and at least one methanation catalyst at a temperature suitable for further reducing said amount of CO in said reformate fuel gas, forming a second stage reformate fuel gas having a further reduced CO contact; and
contacting said second stage reformate fuel gas with said at least one methanation catalyst, resulting in a third stage reformate fuel gas in which said CO content is less than about 50 ppm.

11. A method in accordance with claim 10, wherein said CO content of said third stage reformate fuel gas is less than about 20 ppm.

12. A method in accordance with claim 10, wherein said at least one water-gas shift catalyst, said catalyst mixture and said at least one methanation catalyst are sequentially disposed in one reactor vessel.

13. A method in accordance with claim 10, wherein a first stage temperature of said first stage reformate fuel gas is in a range of about 190° C. to bout 250° C.

14. A method in accordance with claim 13, wherein a second stage temperature of said second stage reformate fuel gas is in a range of about 170° C. to about 200° C.

15. A method in accordance with claim 12, wherein a temperature of said catalyst mixture decreases in a direction of said at least one methanation catalyst.

16. A method in accordance with claim 12, wherein said catalyst mixture comprises a catalyst gradient whereby a concentration of said at least one methanation catalyst in said catalyst mixture increases in a direction towards said at least one methanation catalyst.

17. In a system for generating electricity comprising at least one fuel cell and at least one fuel processor, the improvement comprising:
said at least one fuel processor comprising a reformer vessel suitable for reforming said hydrocarbon fuel to a reformed gas mixture comprising CO, CO₂, H₂O and H₂;
a reactor vessel having a water-gas shift catalyst zone, a mixed catalyst zone downstream of said water-gas shift catalyst zone, and a methanation catalyst zone downstream of said mixed catalyst zone in fluid communication with said reformer vessel; and
at least one water-gas shift catalyst disposed in said water-gas shift catalyst zone, at least one methanation catalyst disposed in said methanation catalyst zone, and a mixture of said at least one water-gas shift catalyst and said at least one methanation catalyst disposed in said mixed catalyst zone.
